(19) United States
(12) Patent Application Publication
(10) Pub. No.: US 2025/0199540 A1
(43) Pub. Date: Jun. 19, 2025

(54) CONTROL APPARATUS, CONTROL METHOD, MEASUREMENT SYSTEM, AND PROGRAM

(71) Applicant: Nippon Telegraph and Telephone Corporation, Tokyo (JP)

(72) Inventors: Toru Nakamura, Musashino-shi, Tokyo (JP); Tatsuya IIZUKA, Musashino-shi, Tokyo (JP); Naoko KOSAKA, Musashino-shi, Tokyo (JP); Tsuneko Kura, Musashino-shi, Tokyo (JP); Yusuke UMEMIYA, Musashino-shi, Tokyo (JP); Masaki HISADA, Musashino-shi, Tokyo (JP)

(21) Appl. No.: 18/844,139

(22) PCT Filed: Mar. 16, 2022
(86) PCT No.: PCT/JP2022/011977

§ 371 Date: Sep. 5, 2024

(51) Int. Cl. G05D 1/617; G05D 1/689; G05D 1/69; G05D 105/80

(52) U.S. Cl. CPC G05D 1/621; G05D 1/689; G05D 1/69; G05D 2105/80

(57) ABSTRACT

A measurement system 1 is the measurement system 1 including a flight vehicle 30 that flies in a measurement zone to perform measurement; and a management device 10 that controls a flight path of the flight vehicle 30. The management device 10 includes an information collection unit 11 that collects the wind conditions in the measurement zone; and a flight plan management unit 12 that plans, based on the wind conditions, a flight path in which the flight vehicle enters the measurement zone from windward or leeward and flies directly against the wind in the area. The flight vehicle 30 flies along the flight path to perform measurement in the measurement zone.

### TECHNICAL FIELD

The present invention relates to a control device, a control method, a measurement system, and a program.

### BACKGROUND ART

Airplane control is often difficult even for skilled pilots. Manipulation requires advanced knowledge, experience, and concentration, and an automatic navigation program is essential in order to reduce a human burden during long distance flight. On the other hand, various types of unmanned airplanes, mainly rotorcraft, have become widespread. In particular, unmanned airplanes of a type that simultaneously drive a plurality of rotors including a control program have become widespread.

Unmanned airplanes are used in a wide range of fields such as image-capturing, observation, and topographic surveying. The weather on the flight path is important for flight. Turbulence, heavy rain, and the like have a great influence on flight, intended image-capturing, and measurement. In particular, small unmanned airplanes are extremely affected by wind, and a wind speed equal to or higher than the maximum speed of the airplane itself is not uncommon in the sky. Depending on the purpose of flight, it is necessary to take measures such as avoiding an area with bad weather or postponing the flight until the weather becomes good.

In the case of purposes unrelated to bad weather, such as landscape image-capturing, equipment inspection, and topographic surveying, avoidance of bad weather is the first priority. In general, airplanes tend to avoid bad weather because of emphasis on flight safety, but near an airport which is a landing point or on a path thereof, flight is performed even in the certain bad weather while setting safety standards for business reasons. In a case where the purpose is to capture an image of bad weather or to observe extreme weather, flight in bad weather may be essential and inevitable.

Cited Literature 1 reports accuracy evaluation of drone observation, but there are many problems such as not only measurement accuracy but also observation using a plurality of drones and a flight control method. In particular, in order to perform continuous measurement for a long period of time and a long distance flight, how to fly with energy saving is an important factor.

### CITATION LIST

### Non Patent Literature

Non Patent Literature 1: Tatsuya Iizuka, Naoko Kosaka, Tsuneko Kura, Yusuke Umemiya, Takashi Shitara, “Drone ni yoru kotonaru tenkoka ni okeru enchoku profile taiki kankyo keisoku no seido hyoka (in Japanese) Accuracy Evaluation of Measurement of Vertical Profile of Atmospheric Environment under Different Weather Conditions by Drone”, The Japan Society of Meteorology, Proceedings of the 2021 Annual Autumn Meeting, p. 215

### SUMMARY OF INVENTION

### Technical Problem

Depending on the purpose, flight in bad weather may be inevitable, and there are many cases where operation in rain or strong wind is required.

In particular, a strong wind has a great influence on the flight itself, and thus how to realize an efficient flight in consideration of the influence of wind is a problem. For example, in weather observation, it is desirable to stay at a fixed point continuously for as long as possible. Further, due to fuel or cell issues, low energy flight is desired during observations.

The present invention has been made in view of the above, and an object thereof is to efficiently stay and fly in a predetermined area.

### Solution to Problem

According to an aspect of the present invention, there is provided a control device that controls a flight path of a flight vehicle that flies in a predetermined area to perform measurement, the control device including: a collection unit that collects wind conditions in the area; and a planning unit that plans, based on the wind conditions, a flight path in which the flight vehicle enters the area from windward or leeward and flies directly against the wind in the area.

According to another aspect of the present invention, there is provided a control method for controlling a flight path of a flight vehicle that flies in a predetermined area, in which a computer collects wind conditions in the area, and plans, based on the wind conditions, a flight path in which the flight vehicle enters the area from windward or leeward and flies directly against the wind in the area.

According to still another aspect of the present invention, there is provided a measurement system including: a plurality of flight vehicles that fly in a predetermined area to perform measurement; and a control device that controls a flight path of the flight vehicles, in which the control device includes a collection unit that collects wind conditions in the area, and a planning unit that plans, based on the wind conditions, a flight path in which the flight vehicle enters the area from windward or leeward and flies directly against the wind in the area, the flight vehicle flies according to the flight path to perform measurement in the area, and the planning unit plans a flight path in which the flight vehicles continue measurement in the area by replacing the flight vehicle staying in the area.

### Advantageous Effects of Invention

According to the present invention, it is possible to efficiently stay and fly in a predetermined area.

### BRIEF DESCRIPTION OF DRAWINGS

FIG. 1 is a diagram showing an example of a configuration of a measurement system of the present embodiment.

FIG. 2 is a diagram showing an example of a processing flow of a management device.

FIG. 3 is a diagram showing an example of a processing flow of a flight vehicle.

FIG. 4 is a diagram showing an example of a flight path to a measurement zone.

FIG. 5 is a diagram showing an example of an entry method when there is strong wind in the measurement zone.

FIG. 6 is a diagram showing an example of an entry method when there is weak wind in the measurement zone.

FIG. 7 is a diagram showing an example of a flight path in which the flight vehicle stays in the measurement zone when there is weak wind in the measurement zone.

FIG. 8 is a diagram showing an example of a flight path in which the flight vehicle stays in the measurement zone when wind conditions differ between upper and lower layers.

FIG. 9 is a diagram illustrating an example of a hardware configuration.

### DESCRIPTION OF EMBODIMENTS

### [Configuration of Measurement System]

Hereinafter, an embodiment of the present invention will be described with reference to the drawings.

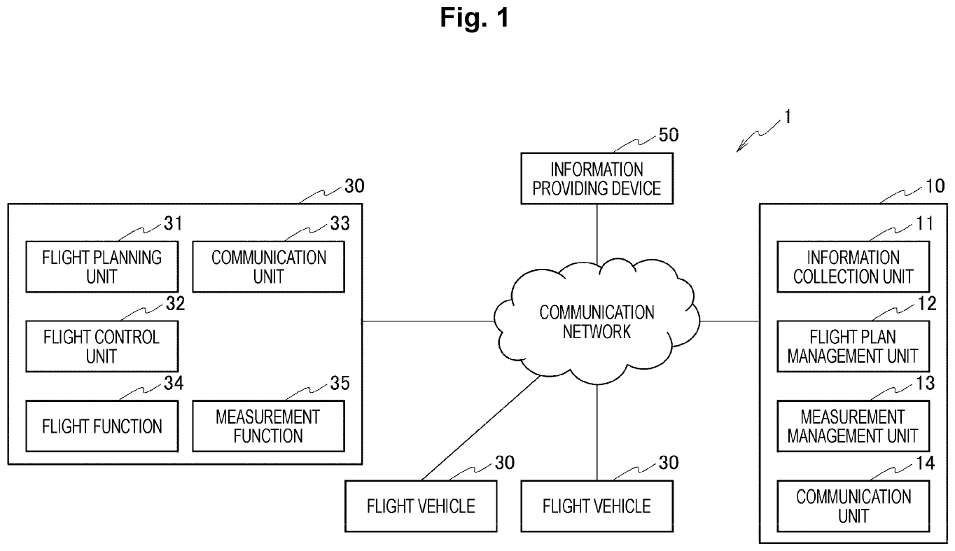

An example of a configuration of a measurement system 1 according to the present embodiment will be described with reference to FIG. 1. The measurement system 1 shown in FIG. 1 includes a management device 10 and a flight vehicle 30. The measurement system 1 may include a plurality of flight vehicles 30. The management device 10 plans the flight path of the flight vehicle 30 based on the wind conditions in the measurement zone including the measurement point and the wind conditions to the measurement zone. The flight vehicle 30 flies along a flight path to perform measurement in the measurement zone.

The management device 10 includes an information collection unit 11, a flight plan management unit 12, a measurement management unit 13, and a communication unit 14.

The information collection unit 11 collects various types of weather information, satellite photograph data, and the like from an information providing device 50, integrates the information, estimates the wind conditions on the flight path from the base of the flight vehicle 30 to the measurement point and the wind conditions of the measurement point, and creates the wind condition map. The information providing device 50 is, for example, an external service that provides weather information and satellite information. The information collection unit 11 may collect the wind conditions actually measured by the flight vehicle 30. The information collection unit 11 updates the wind condition map as needed based on the flight status of each flight vehicle 30, sensor data, external information, and the like. The information collection unit 11 may provide the estimated wind condition information to each flight vehicle 30 as needed.

Based on a measurement plan generated by the measurement management unit 13 described later and wind conditions collected by the information collection unit 11, the flight plan management unit 12 creates a flight plan of the entire flight path from departure to return of the flight vehicle 30 such that measurement indicated by the measurement plan can be performed. For example, the flight plan management unit 12 plans a flight path in which the flight vehicle enters the measurement zone in which measurement is performed from windward or leeward and flies directly against the wind in the area such that the flight vehicle can stay in the measurement zone continuously for a long period of time. Details of the flight path will be described later. The created flight plan is distributed to the flight vehicle 30. The flight plan includes, for example, a departure time, a flight path, a measurement start time, and a measurement time. The flight plan management unit 12 may update the flight plan in accordance with the sequentially updated wind condition map and the actual flight status of the flight vehicle 30.

The flight plan management unit 12 may share measurement using a plurality of flight vehicles 30 and create a flight plan of each flight vehicle 30 such that measurement in the measurement zone can be continued by replacing the flight vehicles 30 staying in the measurement zone, or may manage allocation of backup aircraft when the flight vehicle 30 cannot perform the target measurement.

The measurement management unit 13 creates a measurement plan. For example, in order to perform an unperformed measurement, the measurement management unit 13 determines a measurement point and a measurement time to be measured next, and creates a measurement plan. In addition to the measurement, a plan for imaging or inspection may be created. Here, since it is not necessary to distinguish actions such as measurement, imaging, and inspection, these actions are simply referred to as measurement. The measurement management unit 13 designates a measurement target, a measurement point, a measurement time, and the like, but does not manage resources necessary for measurement such as assignment of the flight vehicle 30 to be used. For example, in the case of a measurement plan that requires a plurality of flight vehicles 30, the flight plan management unit 12 creates a flight plan for the plurality of flight vehicles 30 that can perform the measurement plan.

The communication unit 14 transmits the flight plan and the wind condition information to each flight vehicle 30, and receives the flight status and the measured wind conditions from each flight vehicle 30. The communication unit 14 can use various mobile communication networks including satellite communication, and wireless communication means for direct communication.

The flight vehicle 30 includes a flight planning unit 31, a flight control unit 32, a communication unit 33, a flight function 34, and a measurement function 35. The flight vehicle 30 measures a target while flying, and may be a vertical take-off and landing aircraft or a rotary wing aircraft capable of hovering in addition to a general fixed wing aircraft. Examples of the engine and propulsion system for flight include a motor operated by a battery, a fuel-powered reciprocating engine, a turboprop engine and a propeller, a turbofan engine, and the like, but the system is not limited herein.

The flight planning unit 31 determines a flight path at that time by instructing the flight control unit 32 according to the flight plan distributed from the management device 10. The flight planning unit 31 receives distribution from the management device 10 even during the flight of the flight vehicle 30 and modifies the flight plan. The flight planning unit 31 may modify the flight plan based on the deviation between the actual flight path and the plan, the wind condition information distributed from the management device 10, and the sensor information and the flight status obtained by the flight vehicle 30.

The flight control unit 32 controls the movement of each device of the flight function 34 based on an instruction from the flight planning unit 31.

The communication unit 33 communicates with the management device 10. The communication unit 33 may communicate with another flight vehicle 30.

The flight function 34 includes an engine and a propeller that generate thrust, a wing for obtaining lift, an auxiliary wing and a rudder for flight control, a flap for elevator and lift control, and various devices similar thereto. The flight function 34 is a function of a device for flight provided in a general airplane.

The measurement function 35 includes various sensors for performing intended measurement. The measurement function 35 acquires and accumulates sensor information using various sensors at a measurement point. The measurement function 35 may transmit the sensor information to the management device 10 or another flight vehicle 30 in response to a setting in advance or an instruction from the management device 10.

Although the management device 10 and the flight vehicle 30 are configured separately in FIG. 1, the management device 10 may be mounted on the flight vehicle 30. Alternatively, the flight vehicle 30 may have some of the functions of the management device 10. For example, the functions of the information collection unit 11 and the flight plan management unit 12 included in the management device 10 may be mounted on the flight vehicle 30 as a control device that controls the flight path of the flight vehicle 30, and the flight vehicle 30 may collect wind conditions and plan the flight path to the measurement zone. Alternatively, any one of the plurality of flight vehicles 30 may have the function of the management device 10, and the flight vehicle 30 having the function of the management device 10 may manage another flight vehicle 30.

### [Operation of Measurement System]

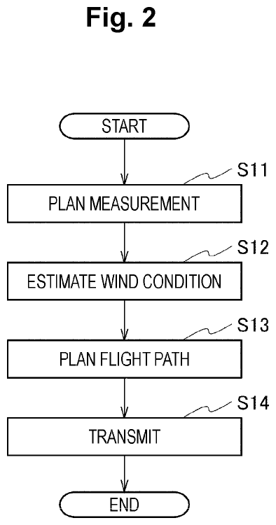

An example of a processing flow of the management device 10 will be described with reference to a flowchart shown in FIG. 2.

In step S11, the management device 10 creates a measurement plan. The person in charge may input the measurement plan to the management device 10.

In step S12, the management device 10 collects various weather forecast information, satellite photograph data, and the like, and estimates wind conditions on a path from the base to the measurement zone and in the measurement zone.

In step S13, the management device 10 creates a flight plan based on the measurement plan and the wind conditions.

In step S14, the management device 10 transmits the created flight plan to the flight vehicle 30.

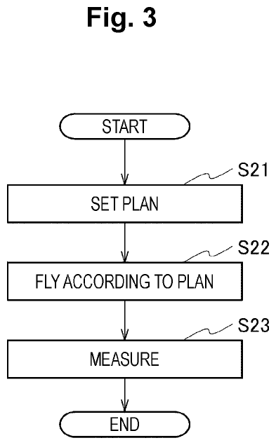

Note that, even during the flight of the flight vehicle 30, the management device 10 may continuously estimate the wind conditions in step S12, create the flight plan in step S13 according to the wind conditions, and transmit the updated flight plan to the flight vehicle 30. An example of a processing flow of the flight vehicle 30 will be described with reference to a flowchart shown in FIG. 3.

In step S21, the flight vehicle 30 receives distribution of the flight plan from the management device 10 and sets the flight plan.

In step S22, the flight vehicle 30 flies according to the flight plan.

In step S23, flight vehicle 30 performs measurement in the measurement zone.

Note that, although an example in which the management device 10 plans a flight path has been described above, the management device 10 may assign a measurement zone to be measured to each flight vehicle 30, each flight vehicle 30 may collect wind conditions, and each flight vehicle 30 may plan a flight path to the measurement zone and fly.

### [Measurement Zone]

Next, the measurement zone will be described.

The range of measurement varies depending on the purpose. For example, there are a measurement continuously performed on coordinates fixed with respect to the ground, a measurement performed while maintaining a certain position with respect to a moving object (for example, ships, flight vehicles, or weather phenomena such as typhoons), a measurement performed while circling at a certain distance along a contour of the measurement target, and the like. In each case, the point at which the measurement is performed for one airframe at a certain point in time will be given by one coordinate. In the actual operation, it is difficult to completely fix the absolute coordinates due to the influence of the airflow, the movement of the object, or the movement capability of the airplane itself.

In addition, it is not always required that the measurement be performed exactly in accordance with the coordinates depending on the purpose of the measurement, and it is not a problem that the measurement point is shifted within an allowable range depending on the purpose. Therefore, although an ideal measurement point (hereinafter ideal points) is determined in terms of calculation, the system is operated after an allowable range around the ideal point is defined for each purpose. As an example, a case of a cylinder having a diameter α and a height β centered on an ideal point will be described. It is considered that the target measurement can be performed by staying in the cylinder and performing the measurement. The space of the cylinder is called a measurement zone, or simply a zone. The measurement zone is not limited to a cylinder, and may have other shapes.

### [Flight Path]

Before describing the flight path, various speeds of the flight vehicle 30 will be described.

The speed of an airplane includes a speed (airspeed) with respect to an air mass including the airframe and a speed (ground speed) with respect to the ground. Unless otherwise specified, the speed of an airplane refers to the airspeed. In an airplane flying with fixed wing lift, the stall speed changes depending on the aircraft design, take-off weight, attitude, and the like. The speed at which some buffers are loaded on the stall speed, that is, the minimum speed at which the vehicle can fly safely without stalling, is referred to as the minimum safe speed. The speed at which the flight energy consumption per moving distance is minimized is referred to as a cruise speed. Further, the speed at which the flight energy consumption per unit time is minimized is referred to as a stay speed. Since being in a safe flight condition is a minimum condition, basically, the stay speed is equal to the minimum safe speed. However, when low energy flight is intended, the speed is specified as the stay speed. Electric energy, fuel, and the like stored in a battery, which is the cost of flight, are collectively referred to as flight energy consumption.

Next, the flight path will be described. The flight takes place in three-dimensional space. Generally, ascent and descent are controlled by changing the angle of attack of the wings by pitch control of the airframe by an elevator or the like. The airspeed changes even at the same engine output depending on the ascent and descent. Since the maximum speed also changes, horizontal movement is naturally affected. Here, a flight path of horizontal movement will be described.

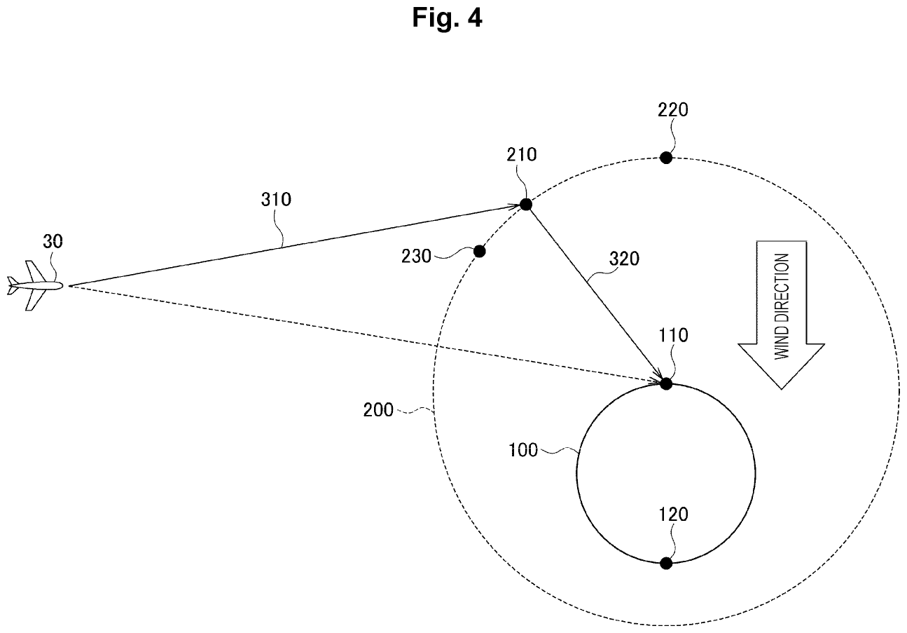

FIG. 4 shows an example of flight paths 310 and 320 to a measurement zone 100. A windward midpoint 110 or a leeward midpoint 120 of the measurement zone 100 is defined as an entry point into the measurement zone. In FIG. 4, the windward midpoint 110 of the measurement zone 100 is set as an entry point. When the measurement zone 100 is a circle, among the points where a straight line parallel to the wind direction passing through the center of the circle intersects with the circumference, a point on the windward side is referred to as the windward midpoint 110, and a point on the leeward side is referred to as the leeward midpoint 120. The wind direction is a direction from the windward midpoint 110 to the leeward midpoint 120.

An approach circle 200 centered on the entry point 110 into the measurement zone and having a radius of a predetermined distance is set, and a check point 210 is set on the approach circle 200. The check point 210 is set on the windward side of a straight line connecting the current position of the flight vehicle 30 and the entry point 110. The flight path 310 is from the current position to the check point 210, and the flight path 320 is from the check point 210 to the entry point 110.

The management device 10 sets the entry point 110 to the measurement zone 100 and the check point 210 based on the wind conditions, and plans the flight paths 310 and 320. The management device 10 or the flight vehicle 30 may reset the entry point 110 and the check point 210 according to the wind condition change.

The flight vehicle 30 passes through the check point 210 and enters the measurement zone 100 from the entry point 110. The flight vehicle 30 performs flight control according to a distance to the measurement zone 100. Specifically, remote control at a distance including a control immediately after departure, proximity control in the vicinity of target coordinates, in-zone control after entering the zone, and return control until leaving the zone and returning to the base are performed in order from departure. In the case of FIG. 4, remote control is performed in the flight path 310, proximity control is performed in the flight path 320, and in-zone control is performed in the measurement zone 100. The remote control, the proximity control, and the in-zone control will be described below.

### [Remote Control]

In the remote control, flight control is performed in consideration of reachability, arrival time, and arrival energy. Reachability is the possibility or ease of reaching a destination. The arrival time is the arrival time to the destination. The arrival energy is the total amount of energy consumed in flight to the destination.

When there is no wind and it is calm until the destination, it is possible to fly with a straight line connecting the current position and the destination as a flight path, but in reality, such a situation is rare. When the flight vehicle is positioned on the leeward side at the point in time when the flight vehicle approaches the destination, the flight vehicle may not be able to reach the destination in a case where the wind speed is higher than the maximum speed of the flight vehicle 30. In order to increase the reachability, in order to cope with a wind condition change at the time of approach, it is preferable to take a path detouring to the windward side in consideration of safety. However, when the flight vehicle makes an extremely large turn or the flight in the windward direction increases, the arrival time and the arrival energy increase. For example, assuming that a windward midpoint 220 of the approach circle 200 in FIG. 4 is a via-point, after reaching the windward midpoint 220, the flight vehicle can reach the entry point 110 only by being flown by the wind, but the flight distance to the windward midpoint 220 is long, and the total amount of loss due to the headwind is also large. In addition, when a point 230 on the leeward side of the check point 210 is set as a via-point, there is a possibility that the flight vehicle 30 cannot reach the entry point 110 even when the flight vehicle flies at the maximum speed due to the wind condition change. When the flight vehicle cannot reach the destination, the flight vehicle has to wait for a wind condition change by making a detour or making a standby flight again, adjust with another vehicle to set another destination, or return. Reachability is extremely important as the original flight objective is not fulfilled.

In the remote control, the check point 210 to enter the approach circle 200 is determined from the estimated wind conditions in the measurement zone 100 and the speed of the flight vehicle 30 such that the flight vehicle can reach the measurement zone 100 with low energy flight and more reliably. There are variations in the determination method, but in consideration of reachability, the check point 210 is determined such that a more distant path is obtained as the wind speed is higher. A straight path is assumed from the current position of the flight vehicle 30 to the check point 210. A wind component orthogonal to the straight line is referred to as a cross wind component. The wind component parallel to the straight line directly affects the approach speed, but does not affect the path selection except when the speed is higher than the speed of the flight vehicle 30. However, as a real problem, in the case of a cross wind close to the maximum speed, it is difficult to approach the destination, and the wind speed at which the flight vehicle gives up reaching the destination is set due to temporal energy constraints. Since the energy required for flight control is smaller than the energy required for flight propulsion, it is ideally considered that the setting of the flight azimuth can be changed at an energy cost of 0. When a headwind close to the maximum speed of the flight vehicle 30 is blowing, the flight vehicle flies in the direction orthogonal to the straight line to the target point, and searches for a place where the wind condition changes.

### [Proximity Control]

In the proximity control, the flight vehicle 30 heads from the check point 210 to approach the entry point 110 in a straight line. It is assumed that drift flight is performed in which the airplane heading is controlled according to the wind conditions at the site. Specifically, the flight vehicle flies while adjusting the airplane heading such that the component of the wind in the vertical direction with respect to the straight line connecting the flight vehicle 30 and the entry point 110 and the airspeed of the flight vehicle 30 having the vertical component with respect to the same straight line are balanced. In principle, when the wind speed of the cross wind component is lower than the maximum speed of the flight vehicle 30, it is possible to fly along a straight path to the destination by drift flight.

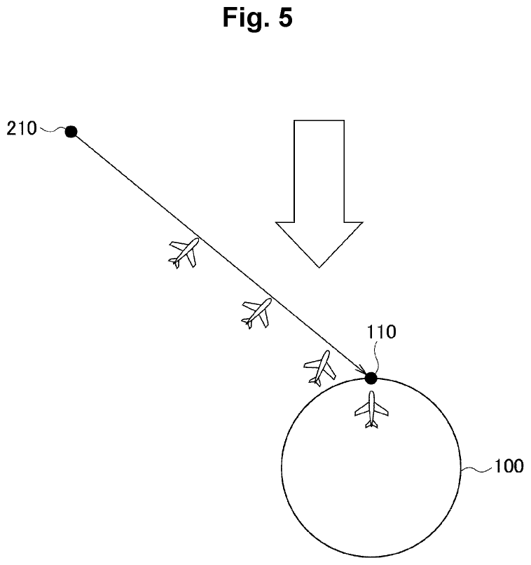

When the wind speed in the measurement zone 100 is higher than or equal to the minimum safe speed of the flight vehicle 30, a flight path with the windward midpoint 110 of the measurement zone 100 as an entry point is planned as shown in FIG. 5. From the check point 210 to the entry point 110, drift flight with the airplane heading directed in the windward direction is performed, the airplane heading is adjusted before reaching the entry point 110, and the flight vehicle 30 is made to be directly against the wind. Then, the flight vehicle enters the measurement zone 100 while retreating relative to the ground.

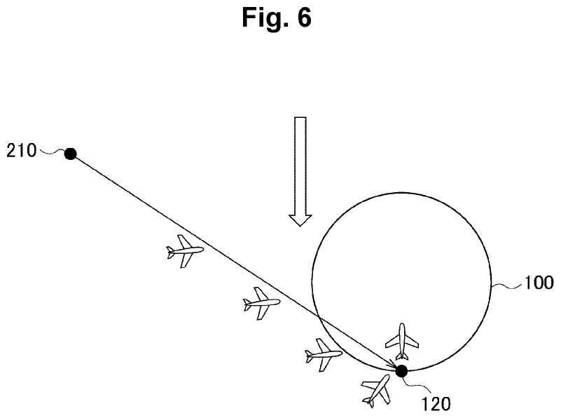

When the wind speed in the measurement zone 100 is lower than the minimum safe speed of the flight vehicle 30, a flight path with the leeward midpoint 120 of the measurement zone 100 as an entry point is planned as shown in FIG. 6. The flight vehicle 30 advances and enters the measurement zone 100 directly against the wind from the leeward midpoint 120 of the measurement zone 100.

### [In-Zone Control]

In in-zone control, flight paths are selected in which the flight vehicle can stay in the zone continuously for a long period of time. Specifically, the flight vehicle 30 flies such that the ground speed becomes as low as possible directly against the wind and not falling below the minimum safe speed.

When the wind speed exceeds the minimum safe speed and is equal to or less than the maximum speed, the ground speed can be set to 0 by matching the wind speed with the airspeed of the flight vehicle 30. In a case where the flight vehicle 30 flies near the outer periphery of the zone, there is a possibility that the flight vehicle goes out of the zone due to the wind condition change. In addition, when the flight vehicle 30 flies at a speed close to the maximum speed, flight energy consumption is large. Therefore, the flight vehicle 30 also moves up and down while moving near the center of the zone, and searches for a layer close to the minimum safe speed. Stay flight with low energy is possible when the ground speed is maintained at 0 as much as possible by being positioned in the zone center at a layer close to the minimum safe speed.

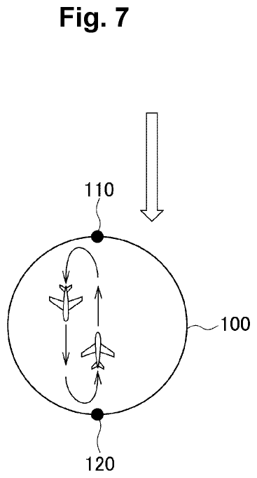

When the wind speed is equal to or lower than the minimum safe speed, the ground speed cannot be set to 0, and the flight vehicle has to move forward. When the wind speed is equal to or lower than the minimum safe speed, as shown in FIG. 7, the flight vehicle 30 enters the measurement zone 100 from the leeward midpoint 120, and flies toward the windward midpoint 110 to stay in the measurement zone 100 for a long period of time. When the flight vehicle 30 approaches the windward midpoint 110, the flight vehicle turns not to go out of the measurement zone 100 and flies toward the leeward midpoint 120. When the flight vehicle 30 approaches the leeward midpoint 120, the flight vehicle turns not to go out of the measurement zone 100 and flies toward the windward midpoint 110. The flight vehicle 30 repeats such flight to stay in the measurement zone 100. When there is room in the upper space in the zone, the ground speed can be reduced by ascending during repeated flight. It is possible to lower the ground speed by flying at the entire altitude in the zone, searching for a layer in which the wind speed is close to the minimum safe speed, and flying toward the wind in the layer.

In a case where the wind speed exceeds the maximum speed of the flight vehicle 30, even when the flight vehicle flies at the maximum speed directly against the wind, the flight vehicle moves while retreating to the leeward side relative to the ground. The flight vehicle 30 is moved to a lower layer or an upper layer to search for a layer with a lower wind speed. When there is a layer with a wind speed equal to or lower than the maximum speed, the flight shifts to stay flight in the layer. When the flight vehicle 30 retreats to the zone boundary and moves out of the zone, it is not possible to return to the zone as it is. A detour path to the windward of the zone is planned, and an entry point on the windward of the zone is aimed for according to the plan. When a detour path for returning to the zone cannot be planned, the flight vehicle 30 returns. At this time, when another flight vehicle 30 can reach the entry point on the windward side of the zone, another flight vehicle 30 may be assigned to the measurement of the zone.

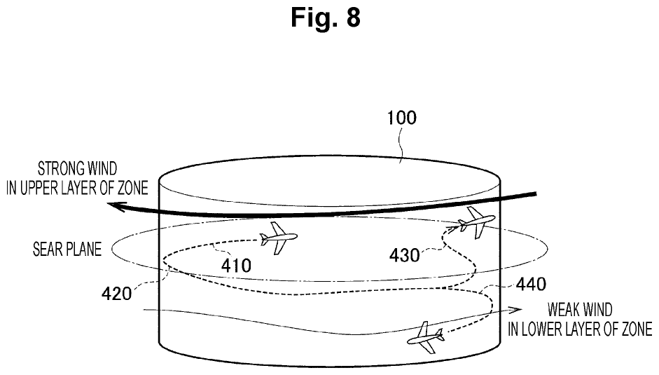

With reference to FIG. 8, an example of path selection of the flight vehicle 30 in a case where the wind direction and the wind speed are different between the upper layer and the lower layer of the measurement zone 100 will be described. In the example of FIG. 8, it is assumed that a strong wind having a wind speed higher than the maximum speed of the flight vehicle 30 is blowing in the upper layer of the zone, and a weak wind having a wind speed lower than the minimum safe speed of the flight vehicle 30 is blowing in the lower layer of the zone.

The flight vehicle 30 enters while retreating from the windward midpoint (the right side in the drawing) of the strong wind in the upper layer of the zone, and advances while retreating in the upper layer of the zone as indicated by a flight path 410. At this time, more appropriate wind speed positions in the vertical and horizontal directions may be searched for in the zone.

As indicated by a flight path 420, the flight vehicle 30 passes through the sear plane and advances to the leeward side of the weak wind of the lower layer of the zone, in the lower layer of the zone.

When the flight vehicle 30 moves to the vicinity of the outer periphery of the zone, the flight vehicle selects a flight path to return to the upper layer of the zone or stay in the lower layer of the zone.

In the case of returning to the upper layer of the zone, the flight vehicle 30 ascends to the upper layer of the zone as indicated by a flight path 430, and advances while retreating in the upper layer of the zone with the airplane heading directed toward the windward side.

When staying in the lower layer of the zone, the flight vehicle 30 turns not to go out of the zone as indicated by a flight path 440, and advances in the windward direction in the lower layer of the zone with the airplane heading directed toward the windward side.

The flight vehicle 30 may select the flight path under the in-zone control based on the wind conditions in the zone, or the flight vehicle 30 may transmit the wind conditions in the zone to the management device 10, and the management device 10 may select the flight path based on the wind conditions and transmit the selected flight path to the flight vehicle 30.

### Operations and Effects

As described above, the measurement system 1 of the present embodiment is the measurement system 1 including the flight vehicle 30 that flies in the measurement zone to perform measurement; and the management device 10 that controls the flight path of the flight vehicle 30. The management device 10 includes the information collection unit 11 that collects the wind conditions in the measurement zone; and the flight plan management unit 12 that plans, based on the wind conditions, a flight path in which the flight vehicle enters the measurement zone from windward or leeward and flies directly against the wind in the measurement zone. The flight vehicle 30 flies along the flight path to perform measurement in the measurement zone. The flight vehicle 30 can stay in the measurement zone for a longer period of time by flying directly against the wind in the measurement zone. Accordingly, the intended measurement can be performed in the measurement zone.

According to the present embodiment, a check point is set on the windward side of the straight line connecting the current position of the flight vehicle 30 and the entry point into the measurement zone, and the flight vehicle passes through the check point such that the flight vehicle can fly on a flight path with low energy consumption and high reachability to the measurement zone.

According to the present embodiment, in the measurement zone, the flight vehicle 30 can stay in the measurement zone with low energy consumption by flying in a layer of wind speed close to the minimum safe speed at which the flight vehicle 30 can safely fly without stalling.

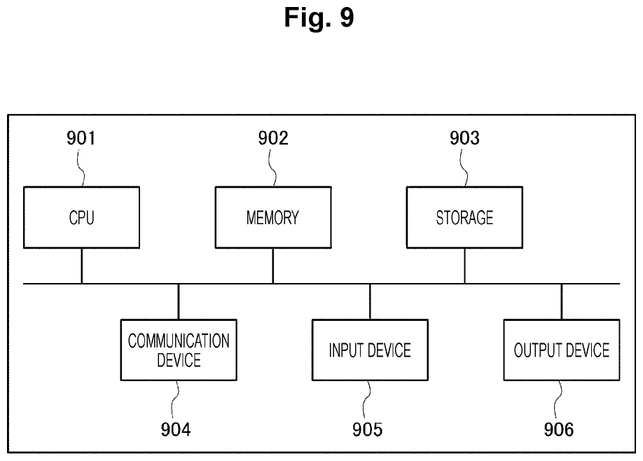

For example, as illustrated in FIG. 9, a general-purpose computer system including a central processing unit (CPU) 901, a memory 902, a storage 903, a communication device 904, an input device 905, and an output device 906 can be used as respective units of the management device 10 and the flight vehicle 30 described above. In this computer system, the CPU 901 executes a predetermined program loaded on the memory 902, thereby realizing respective units of the management device 10 and the flight vehicle 30. This program can be recorded on a computer-readable recording medium such as a magnetic disk, an optical disc, or a semiconductor memory, or can be distributed via a network.

### REFERENCE SIGNS LIST

1 Measurement system
10 Management device
11 Information collection unit
12 Flight plan management unit
13 Measurement management unit
14 Communication unit
30 Flight vehicle
31 Flight planning unit
32 Flight control unit
33 Communication unit
34 Flight function
35 Measurement function

1. A control device that controls a flight path of a flight vehicle that flies in a predetermined area to perform measurement, the control device comprising:
a collection unit, including one or more processors, configured to collect wind conditions in the area; and
a planning unit, including one or more processors, configured to that plan, based on the wind conditions, a flight path in which the flight vehicle enters the area from windward or leeward and flies directly against the wind in the area.

2. The control device according to claim 1, wherein the planning unit is configured to set a passing point on a windward side of a straight line connecting the flight vehicle and an entry point into the area, and plan a flight path via the passing point.

3. The control device according to claim 1, wherein the planning unit is configured to plan a flight path in which the flight vehicle flies in a layer with a wind speed close to a minimum safe speed at which the flight vehicle is capable of flying safely without stalling in the area.

4. A control method performed by a computer for controlling a flight path of a flight vehicle that flies in a predetermined area, the control method comprising:
collecting wind conditions in the area, and
planning, based on the wind conditions, a flight path in which the flight vehicle enters the area from windward or leeward and flies directly against the wind in the area.

5. The control method according to claim 4, wherein a passing point is set on a windward side of a straight line connecting the flight vehicle and an entry point into the area, and a flight path via the passing point is planned.

6. The control method according to claim 4, wherein a flight path in which the flight vehicle flies in a layer with a wind speed close to a minimum safe speed at which the flight vehicle is capable of flying safely without stalling is planned in the area.

7. A measurement system comprising:
a plurality of flight vehicles configured to fly in a predetermined area to perform measurement; and
a control device configured to control a flight path of the flight vehicles, wherein
the control device includes
a collection unit, including one or more processors, configured to collect wind conditions in the area, and
a planning unit, including one or more processors, configured to plan, based on the wind conditions, a flight path in which the flight vehicle enters the area from windward or leeward and flies directly against the wind in the area,
the flight vehicle is configured to fly according to the flight path to perform measurement in the area, and
the planning unit is configured to plan a flight path in which the flight vehicle continues measurement in the area by replacing the flight vehicle staying in the area.

8. A non-transitory computer-readable storage medium storing a program causing a computer to operate as respective units of the control device according to claim 1.
